(19) United States
(12) Patent Application Publication
(10) Pub. No.: US 2026/0019990 A1
(43) Pub. Date: Jan. 15, 2026

(54) METHOD AND APPARATUS FOR SERVICE REQUEST AND PAGING FOR NEXT GENERATION NETWORK

(71) Applicant: InterDigital Patent Holdings, Inc., Wilmington, DE (US)

(72) Inventors: Taimoor ABBAS, Sainte-Julie (CA); Samir FERDI, Kirkland (CA); Michael STARSINIC, Newtown, PA (US); Michel ROY, Candiac (CA); Rocco DI GIROLAMO, Laval (CA); Ulises OLVERA-HERNANDEZ, Sain-Lazare (CA); Zhibi WANG, Woodridge, IL (US); Saad AHMAD, Montreal (CA)

(73) Assignee: InterDigital Patent Holdings, Inc., Wilmington, DE (US)

(21) Appl. No.: 18/771,505

(22) Filed: Jul. 12, 2024

(51) Int. Cl. H04W 68/00; H04W 28/06

(52) U.S. Cl. CPC H04W 68/005; H04W 28/06

(57) ABSTRACT

In some implementations, a method implemented in a first NF may include receiving first information from a second NF during a PDU session establishment procedure or a PDU session modification procedure, where the first information includes an identifier of a third NF. The method may include storing the received first information associated with the PDU session. The method may include receiving a downlink (DL) data notification and at least one of a plurality of second information from the third NF, the DL data notification including DL data to be delivered using the PDU session to a wireless transmit/receive unit (WTRU). Moreover, the device may include determining a state of the WTRU. Also, the device may include sending a request to the second NF to initiate radio resource establishment to activate user plane (UP) resources for the PDU session when it is determined that the WTRU is in a connected state.

### BACKGROUND

6G wireless systems will build on the foundation laid by 5G wireless systems. Network functions communicate with each other using Service Based Interface (SBI). The goal of the Service Base Architecture (SBA) is to enable Network Functions (NFs) to expose services to other NFs so the system may provide the desired functionality. Currently, 5G system architecture does not offer a full service based environment as some network interfaces remain exclusively point-to-point between two entities. Thus, the need exists for an evolved network architecture consistent with the current 5G architecture that offers a full SBA specifically with respect to paging and service requests.

### SUMMARY

Aspects and features of the disclosed embodiments are directed to an evolved network architecture that offers a full SBA specifically with respect to service requests and paging. A system of one or more computers can be configured to perform particular operations or actions by having software, firmware, hardware, or a combination of them installed on the system. When in operation, this causes the system to perform the actions. One or more computer programs can be configured to perform particular operations or actions by including instructions that, when executed by data processing apparatus, cause the apparatus to perform the actions.

In one general aspect, a method may include receiving first information from a second NF during a packet data unit (PDU) session establishment procedure or a PDU session modification procedure. The first information may include an identifier of a third NF. The method may also include storing the received first information associated with the PDU session. Furthermore, the method may include receiving a downlink (DL) data notification and at least one of a plurality of second information from the third NF. The DL data notification includes DL data to be delivered using the PDU session to a wireless transmit/receive unit (WTRU). The method may also include determining the state of the WTRU. Moreover, the method may include sending a request to the second NF to initiate radio resource establishment to activate user plane (UP) resources for the PDU session when it is determined that the WTRU is in a connected state. Other embodiments of this aspect include corresponding computer systems, apparatus, and computer programs recorded on one or more computer storage devices, each configured to perform the actions of the methods.

Implementations may include one or more of the following features. The method where the first information includes at least one of a PDU session ID, or a WTRU ID, where the first information is associated with WTRU context information, and where the plurality of second information includes one or more of: an N4 session ID, PDU session ID, information to identify a QoS flow for a DL data packet, and management information associated with the stored first information. The method where determining the state of the WTRU includes performing at least one of: matching N4 session ID/PDU session ID in the DL data notification with the stored first information and confirming whether the WTRU is in a connected state, a disconnected state, is reachable, or is unreachable. The method may include forwarding DL packet data to the second NF when the second information includes data policy information and the data policy information indicates to buffer data at the second NF. The method may include sending a data notification acknowledgement to the third NF when it is determined that the WTRU is in a connected state, where the data notification acknowledgement includes at least one of a WTRU identifier, PDU session ID, a list of intelligent network base stations (iNB), or WTRU status information. The method may include: receiving a WTRU context update request from the second NF based on the DL data notification received from the third NF; retrieving the WTRU context information associated with the stored first information or requesting a status update from a fourth NF when the WTRU context information stored is not current; and sending a WTRU context update response to the second NF. The method may include sending a failure indication to at least one of the second NF and the third NF to indicate the WTRU is unreachable, where the failure indication includes information indicating to perform at least one of: stop sending data notification, stop buffering DL data, or discard data. The method may include triggering a paging message to notify a fourth NF or a radio access network (RAN) node when it is determined that the WTRU is in an idle state. The method may include selecting one access network and sending a notification to the WTRU of a PDU session over the selected one access network when the WTRU is simultaneously registered over more than one access network. Implementations of the described techniques may include hardware, a method or process, or a computer tangible medium.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates a simplified 5G System architecture;

FIG. 3 illustrates a control plane stack between a WTRU and the AMF;

FIG. 4 illustrates a simplified next Gen Network Architecture with the RAN as SBI gateway;

FIG. 5 illustrates an example signal flow for a network triggered service request using SBI mechanism;

FIG. 6 is an example signal flow for SMS forwarding to a WTRU; and

FIG. 7 is a flow diagram of an exemplary process of a network triggered service request using an SBI.

### DETAILED DESCRIPTION

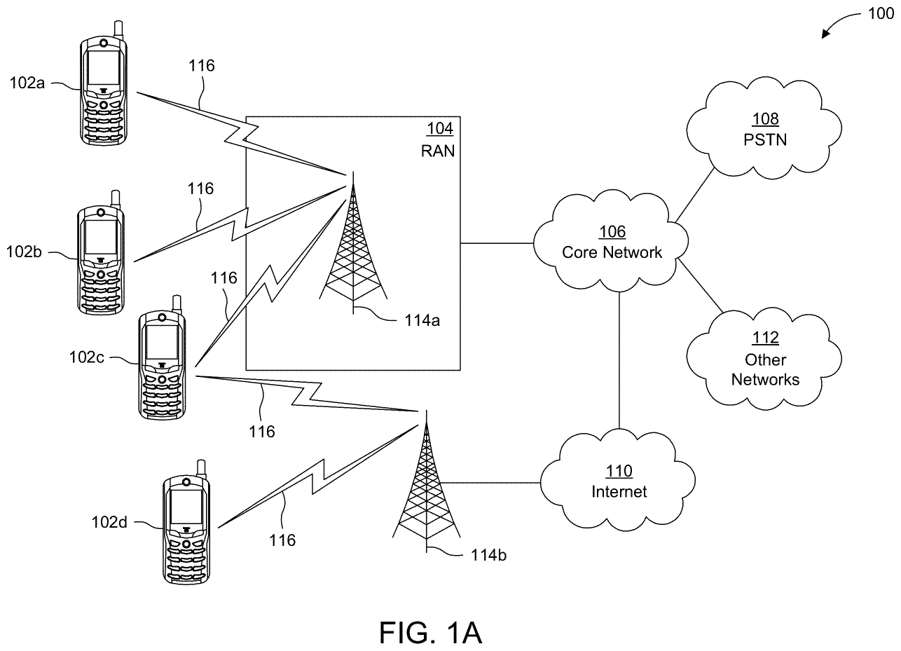

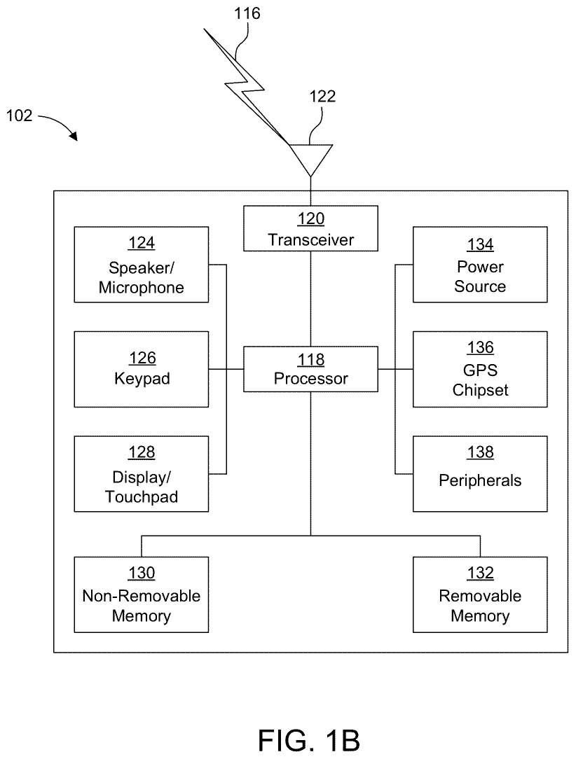

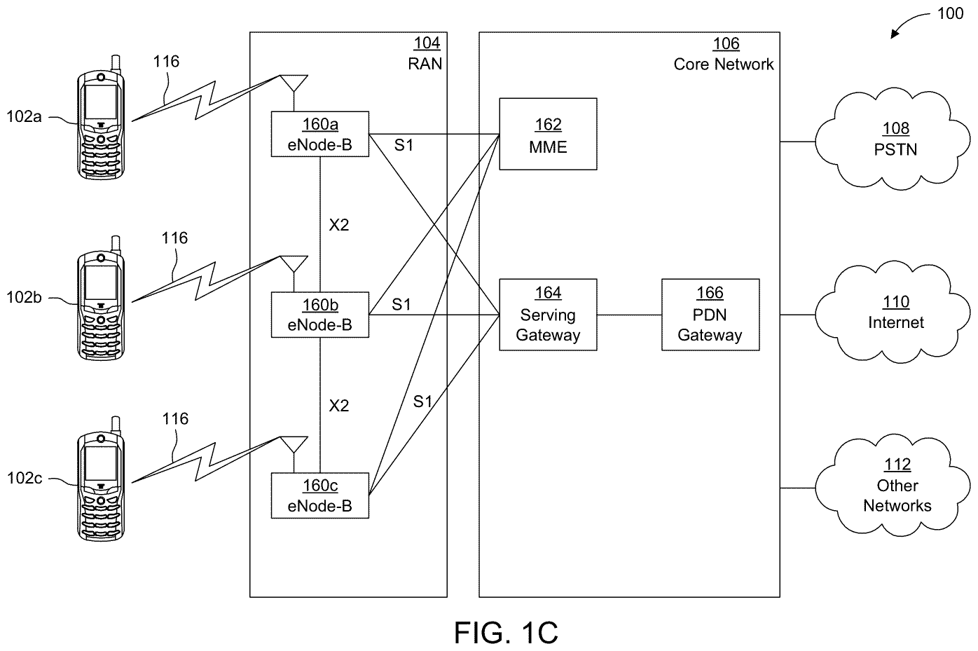

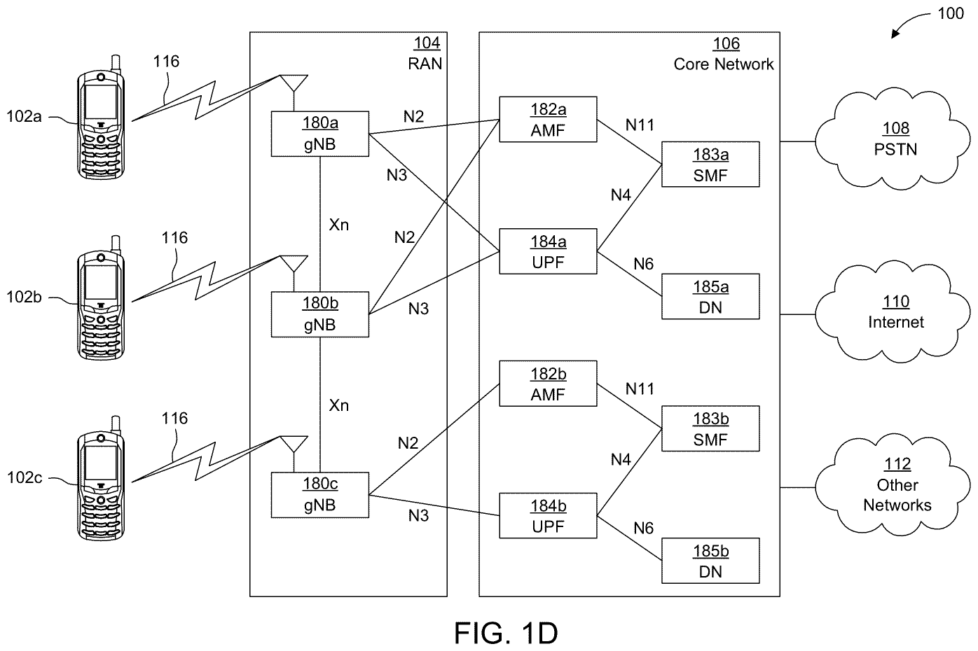

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHZ, 40 MHZ, 80 MHz, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHz, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Notes on Terminology

The term “Distributed NAS” or “Service Based signaling” or “Distributed Control Plane” may be used interchangeably in the following description. “Distributed NAS” or “Service Based signaling” or “Distributed Control Plane” refers to an architecture that supports procedures such that a WTRU is able to send and receive control plane messages to and from network functions without requiring the control plane messages to necessarily traverse a single (i.e. a specific) Network Function (NF) (e.g., that provides routing and security functionality). In the context of this disclosure, a “control plane message” may be transported over a signaling channel, or embedded as application data and transported over a data channel as part of the payload of a Protocol Data Unit (PDU). For example, the architecture of the 5G System does not support “Distributed NAS” because control plane messages between the WTRU and an SMF, PCF, SMSF, and LMF etc. need to go through the AMF. In the current system, when control plane messages, for example Non-Access Stratum (NAS) messages, are exchanged between the WTRU and an SMF, a PCF, a SMSF, or an LMF, the AMF provides NAS messaging termination with security and routing functionality. If the 5G System supported “Distributed NAS”, the WTRU would be able to exchange control plane messages directly with the SMF, PCF, SMSF, and LMF i.e., without having the messages traverse the AMF.

In the following description, an IDLE state generally refers to a state of the WTRU where the WTRU has reduced connectivity with a base station but is still considered to be registered in the network. In an IDLE state, the WTRU may perform some mobility management procedures and monitor paging messages from the base station. The purpose of monitoring paging messages is to determine if the WTRU is being paged. If the WTRU determines that it is being paged, the WTRU may determine to initiate a procedure to transition out the IDLE state and into a CONNECTED state. In a connected state, the WTRU is able to send data to the network and receive data from the network.

The Connection Management procedures in the 5G system are used to establish and release the signaling connection between the WTRU and the AMF.

Connection management comprises the functions of establishing and releasing a NAS signaling connection between a WTRU and the AMF over the N1 interface. The N1 interface is an interface between the WTRU and the AMF. This NAS signaling connection is used to enable NAS signaling exchange between the WTRU and the core network. It comprises both the AN signaling connection between the WTRU and the AN (RRC Connection over 3GPP access or WTRU-to-N3IWF connection over untrusted N3GPP access or WTRU-to-TNGF connection over trusted N3GPP access) and the N2 connection for this WTRU between the AN and the AMF.

Two CM states are used in the WTRU and the AMF. These states reflect the status of the NAS signaling Connection between the WTRU and AMF. The states are called CM-IDLE and CM-CONNECTED.

A WTRU in the CM-IDLE state has no NAS signaling connection established with the AMF over N1. The WTRU cannot send or receive user plane data when the WTRU is in the CM-IDLE state. The network cannot send user plane data to the WTRU when the WTRU is in the CM-IDLE state.

If the WTRU needs to establish a NAS signaling connection, the WTRU must first transition to the CM-CONNECTED state. The WTRU may trigger a transition to the CM-CONNECTED state by sending an Initial NAS message to the network. Registration Request, Service Request or Deregistration Request are examples of Initial NAS messages. Sending an Initial NAS Message initiates the transition from CM-IDLE to CM-CONNECTED state.

When the WTRU is in the CM-IDLE state, the WTRU will monitor, or listen, for pages from the network. If the network needs to send downlink data to the WTRU, the network must first trigger the WTRU to transition to the CM-CONNECTED state. The network may trigger the WTRU to transition to the CM-CONNECTED state by sending a paging message to the WTRU. Reception of the paging message will trigger the WTRU to transition to the CM-CONNECTED state by sending an Initial NAS message to the network.

When the WTRU is in the CM-IDLE state, the WTRU's need to send uplink user plane data or a NAS message can trigger the WTRU to send an initial NAS message. Also, when the WTRU is in the CM-IDLE state, the reception of a paging message can trigger the WTRU to send an initial NAS message.

A Network Triggered Service Request procedure may be triggered when the network (i.e. UPF) receives downlink data for a WTRU and the WTRU is in the CM-IDLE state.

When the WTRU is in the CM-IDLE state, there is no established tunnel between the UPF and the RAN Node. Thus, when the UPF receives downlink data for a WTRU that is in the CM-IDLE state, the UPF is not able to send the downlink data to the RAN Node that serves the WTRU. If there is no tunnel established between the RAN Node and UPF, reception of downlink data by the UPF will trigger the UPF to send a Data Notification to the SMF. Reception of the Data Notification will trigger the SMF to notify the AMF that data need to be sent to the WTRU. Reception of the notification will trigger the AMF to send a paging message to the RAN node. The paging message is a request that the RAN Node page the WTRU. The paging message from the AMF will trigger the RAN Node to page the WTRU. Reception of the paging message from the RAN Node will trigger the WTRU to initiate a service request procedure. Completion of the service request procedure will cause the WTRU to transition to the CM-CONNECTED state and will cause a tunnel to be established between the UPF and RAN Node. Once the tunnel is established between the WTRU and RAN Node, the UPF can send the downlink data to the WTRU.

CM-IDLE is an example of an IDLE state. A WTRU maybe considered unreachable when the WTRU is in an IDLE state.

The term “reachable” is used in this description. The term “reachable” generally refers to a situation where the network is able to send a control plane message or data to the WTRU or generally refers to a situation where the network is able to trigger the WTRU to send a control plane message or data to the network. Paging a WTRU is a procedure that the network may use to trigger the WTRU to send a control plane message to the network. A WTRU that is reachable may be in an IDLE state and periodically listen to the network for a paging message. If the WTRU does not listen periodically to the network for a paging message, then the WTRU might not be reachable. The WTRU periodicity with which the WTRU listens to for a paging message might be determined based on the WTRU's DRX cycle.

The term “unreachable” is used in this description. The term “unreachable” generally refers to a situation where the network is not able to send a control plane message or data until the WTRU first initiates contact with the network. For example, a WTRU is considered “unreachable” when the WTRU is in a state where it does not listen to the network for page. A WTRU that is “unreachable” may become “reachable” by sending a control plane message (e.g., an initial NAS message such as a registration request or a service request) to the network.

The terms “unreachable” and “not reachable” are interchangeable.

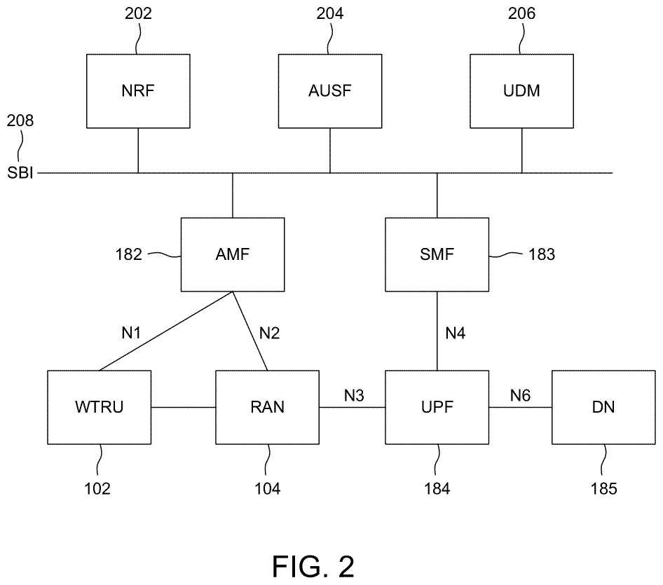

A simplified 5G System Architecture will be described with reference to FIG. 2.

FIG. 2 illustrates a simplified 5G System architecture where only a subset of the NFs in the 5G Core are represented. The NFs, for example access and mobility function (AMF) 182, session management function (SMF) 183, network repository (NRF) 202, authentication server function (AUSF) 204, and unified data management (UDM) 206 communicate with each other using Service Based Interface (SBI) 208. The SBI may, for example, use protocols like HTTP. The goal of the Service Base Architecture (SBA) is to enable NFs to expose services, for example using representational state transfer (RESTful) APIs, to other NFs for the system to provide the desired functionality.

It can be seen that the current 5G system architecture does not offer a full service based environment. While most interaction may be supported using SBIs, there are some interfaces that still remain exclusively as point-to-point interfaces between two entities. These interfaces are shown as (Nx) in FIG. 2 and as described below, they are different from SBI.

WTRU 102 communicates with AMF 182 over N1 using a non-access stratum (NAS) protocol. Control plane messaging between the WTRU 102 and other NFs, for example SMF 183, is done using a NAS transport encapsulation mechanism provided by AMF 182 for the NFs.

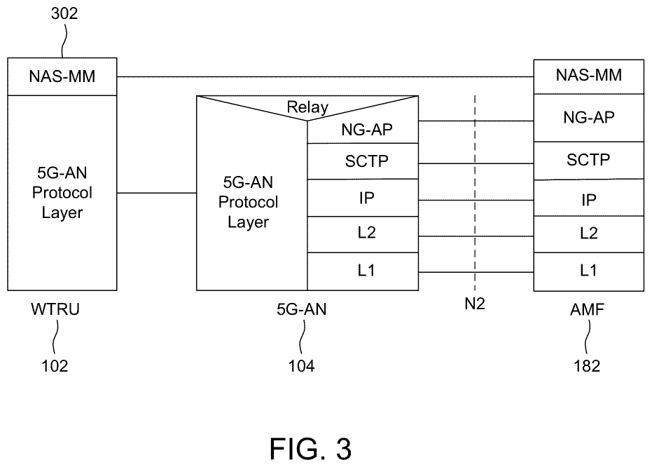

FIG. 3 illustrates a control plane stack between the WTRU and the AMF. As illustrated in FIG. 3, RAN 104 communicates with AMF 182 over N2 using an NG-AP protocol. The NAS protocol for mobility management (MM) 302 functionality supports registration management functionality, connection management functionality and user plane connection activation and deactivation. It is also responsible of ciphering and integrity protection of NAS signaling. Control plane messaging between WTRU 102 and RAN 104 via an access stratum (AS) protocol is done using RRC. RRC is an upper layer/top layer of the 5G-AN protocol layers which is used to transport NAS messages received or sent by RAN 104 over N2.

Current 5G systems have some inherent limitations and inefficiencies. While a monolithically oriented architecture, whereby a single NF implements several individual functionalities, may help reduce the number of nodes and simplify network deployment, such an approach brings increased complexity as the amount of functionality and features that such NF may support reduces its agility and flexibility in terms of development, maintenance and operations, and its inability to scale individual functionalities without affecting other functions also supported by the same NF.

The AMF in the 5G core network (5GC) is a good example of an NF that implements multiple functionalities. In some cases, these functionalities are part of the AMF logic that enables a particular service, such as Paging or Mobility Management. In some other cases, the AMF also supports services without executing the service logic itself but by providing a relay service to enable message transport from the RAN to other Core Network functions such as the SMF, LMF or PCF amongst others. For example, the AMF acts as a single NAS termination point for WTRU communications with the 5GC, among several other functionalities. In another example of how the AMF executes multiple functionalities, the AMF triggers the paging procedure when MT data needs to be sent to the WTRU, and the WTRU state is not CM-CONNECTED, as previously described. A WTRU that needs to communicate with an SMF, PCF, SMSF, or LMF must send and receive messages via the AMF, and such tight coupling is blocking independent scaling of the numerous services offered by the network. For example, during service request or paging procedures the SMF has to coordinate the related reachability signaling such as paging towards the RAN and WTRU via the AMF in order to (re) establish data communications with the WTRU, for the forwarding of DL data. In the event of ongoing excess NAS signaling, the AMF may become a bottleneck hindering the system ability to handle efficiently and in a timely fashion the paging of the UE on behalf of the SMF.

For 6G systems, it is desired to enhance the system architecture for modularity, scalability, and flexibility; for example more aligned with micro-services architecture principles, towards procedures such as, the service request and paging procedure or mobile terminated SMS. The following description addresses how to enhance Core Network architecture to enable better modularity and flexibility for the paging functionality which is currently embedded in AMF, and how to reduce tight coupling between network functions. For example, the SMF or SMSF and AMF are tightly coupled in the sense that messages between the WTRU and SMF or SMSF need to be sent via the AMF.

New architecture proposals are emerging with the possibility to extend the SBI framework beyond the 5GC NFs as shown in FIG. 2. For example, a WTRU 402 may use an evolved NAS mechanism to exchange NAS application messages directly with one or more NFs. As an example, an SBI compliant WTRU may establish an NAS application layer communication directly with an NF, for example a SMF, without going through an AMF thereby enhancing the N1 reference point to offer NAS application services over an SBI.

In another trend, the next generation network is touted as bringing about the so called “connected intelligence” where intelligent networks using artificial intelligence/machine learning (AIML) technology will be able to connect a multitude of “intelligent” things. With huge amounts of data collection from a multitude of devices, for example sensors, Ambient IoT and the like, and with the added high flexibility and adaptability of AIML enabled functionalities, the system will pave the way for new advanced applications such as XR/Metaverse.

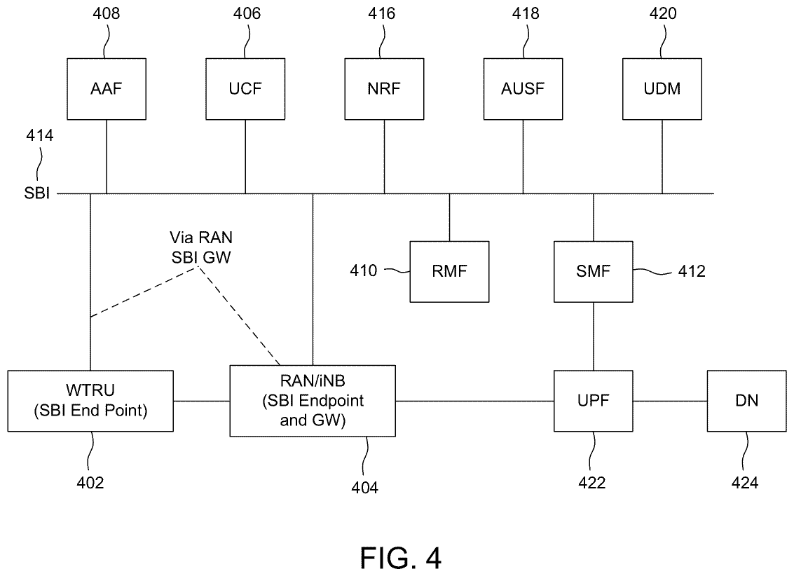

FIG. 4 illustrates a simplified next Generation Network Architecture with the RAN as SBI gateway. The Next Generation Network architecture may extend SBA concepts to the RAN to simplify the network architecture while taking advantage of cloud native and micro-services technology and to enhance architecture capabilities such as scalability, elasticity, and open interfaces.

RAN node 404, which may be referred to as iNB, supports SBI 414 towards the next generation core network which may be referred to as nCN. iNB 404 invokes directly the services needed according to the procedure being performed with WTRU 402.

Once WTRU 402 is successfully identified and authenticated, iNB 404 can invoke the service of a WTRU context management function (UCF). UCF 406 may act as a “representative” of WTRU 402 in the nCN. As such, it maintains stateful information (any state) related to WTRU 402 such a registration/connection states, location, security context, which may be key material for SBI level security and AS security, subscription data from UDM 420, session management information, for example PDU session contexts etc. In other words, UCF 406 provides a “WTRU context as a service” to other NFs in the nCN.

As an example, iNB 404 may invoke the service of a registration and mobility management function (RMF) 410 for access control or mobility updates of WTRU 402. RMF 410 relies on another NF, UCF 406, for stateful information maintenance, and no tight coupled connection exists between iNB 404 and RMF 410. This differs from gNB 104 with AMF 182 as shown in FIG. 2.

For example, iNB 404 may invoke SMF 412 for session management service. SMF 412 is an evolved version of the 5G SMF 183 illustrated in FIG. 2 to support direct interaction with iNB 404 for actions such as user plane resource allocation and AN-CN tunnel establishment. Direct communication between iNB 404 and SMF 412 allows for a reduction of SBI overhead due to messaging with intermediate NFs, for example an AMF.

In this disclosure enhancements to the network triggered service request and paging procedure for DL data and Mobile Terminated SMS are described as an example. The enhancements are based on the Service Based Architecture (SBA) that enables end-to-end communication between the WTRU and the Next Gen Core Network (nCN). The enhancement to the SBA relies on the “distributed NAS” or “Service Based signaling” mechanism, as opposed to current point-to-point NAS between the WTRU and AMF. Therefore, the functionality of the AMF can be broken down to new NFs that provide functionality related to: Authentication/Authorization Function (called AAF), UE Context management Function (UCF), Registration and Mobility management Function (RMF), Tracking and Reachability Function (TRF) etc.

The proposed solutions include the signaling between the NFs such as new RAN node (intelligent-NB or iNB), UCF, TRF, SMF, UPF, SMSF etc. to enable a service request and a paging procedure using end-to-end SBI mechanism between the WTRU and Next Gen Core Network.

An aspect of a network triggered service request is described. A Next Gen RAN node (iNB) acts as an SBI gateway (or distributed NAS anchor point) between a WTRU and a SBI capable Core Network entity. For example, a Tracking and Reachability Function may provide paging functionality, by exchanging SBI-based NAS paging messages, whereas a UCF enables WTRU context exchange and coordination between the SMF and TRF and/or a UPF in the following network triggered service request procedure.

Aspects of the UCF are described. During the PDU session establishment a UCF may receive information from SMF such as SMF ID, UPF ID, PDU session ID, and UE ID. This information is then stored in the UCF, and may be associated with the N4 session ID or PDU session ID. If the information is stored in the UCF, the UCF may use this information to update or to retrieve WTRU context when requested.

The UCF may subscribe to UPF notifications. The UCF may be informed of UPF info by SMF during PDU session setup/modification. The SMF may setup the session binding between UCF and UPF when setting up N4 with UPF.

The UCF may receive a DL Data notification from the UPF including the known, for example previously known, N4 session ID, PDU session ID, Information to identify the QoS flow for the DL data packet and any additional data traffic and management related information that is stored in the UPF for the PDU session.

The UCF may have previously received N4 session ID or PDU session ID from the SMF and it may have stored that information, for example the information may be stored in the WTRU context information.

Upon reception of DL Data notification from the UPF, the UCF may determine the state of the UE. To determine the state of the WTRU, the UCF may perform any of the following actions: match the N4 session ID/PDU session ID, for example from the DL Data notification, with the information stored in the UCF, for example the WTRU context information, and determine the state of the WTRU. The state of the WTRU may be CM-IDLE, CM-CONNECTED, reachable, or unreachable etc.

A UCF may receive a notification from an SMF or a UPF that an N4 Session is active. The UCF may detect that the N4 session is associated with a PDU Session ID. The UCF may determine that the PDU Session ID is associated with the WTRU, and the UCF may determine, based on the fact that an N4 Session that is associated with the WTRU is active, the that the WTRU is in the CM-CONNECTED state and is reachable.

A UCF may receive a notification from a network function (e.g. an AMF) that the WTRU sent a control plane message to the network function and that the WTRU is in a CM_CONNECTED state. For example, the notification may be triggered based on the WTRU sending a control plane message (e.g. a Service Request message) in response to being paged by the network. The notification may include a time value that represents how long the WTRU will remain in the CM_CONNECTED state. For example, the network function may have configured a timer in the WTRU to ensure that the WTRU stays in the CM_CONNECTED state for a time period. The UCF may use the information in the notification to determine that the WTRU is in a CM_CONNECTED STATE and is reachable. If the time value that was indicated in the notification has passed, and the UCF receives no other indication that the WTRU is in a CM_CONNECTED state and reachable, then the UCF may determine that the WTRU is in a CM_IDLE state and is unreachable.

If the UCF in the above step determines that the WTRU state is CM-CONNECTED mode it may send a Data Notification ACK to the UPF that includes the state of the WTRU. The UCF may also send the data policy information to UPF, and the UPF may buffer the data or forward the data to the SMF and the SMF may buffer the data, it may provide the buffer time, or extended time information.

The UCF, based on the above steps, may send Nucf_UpdateUEContextNotification to the SMF that includes SUCI, PDU session ID, a list of iNBs, WTRU status information, which is used later by the SMF for user plane reactivation, for example PDU session establishment or modification procedure if the WTRU is in connected mode.

The UCF may receive a WTRU context update request from the SMF based on DL data notification from the UPF, Nucf_UpdateUEContextRequest, and include SUCI, PDU session ID, 5QI/6QI, SBI container (SBI SM message (DNN, S-NSSAI).

The UCF upon reception of Nucf_UpdateUEContextRequest may retrieve the WTRU context for the WTRU, which may be locally stored in the UCF. If the UCF doesn't have up-to-date status info of the WTRU, it may determine the status by requesting a status update from the TRF. The request to the TRF may include the WTRU ID and the status info request. The TRF may responds the UCF with the status WTRU's info.

The UCF may respond to SMF with UE context update response Nucf_UpdateUEContextResponse and include SUCI, PDU session ID, 5QI/6QI, UE state information.

The UCF may send a failure indication to the SMF and/or UPF to indicate one or more of the following conditions, to stop sending a Data Notification, stop buffering DL data, or to discard data.

The UCF may determine that the WTRU is in a CM-CONNECTED state may not notify the TRF that a paging message is required.

The UCF may trigger the paging message where the UCF may notify the TRF when there is a need to page the WTRU. The Tracking and Reachability Function (TRF) may be notified by the UCF when there is a need to page the WTRU. There may be a new message defined as Ntrf_PagingRequest message, which includes UE ID/WTRU ID, PDU session ID, Registration Area list, Paging DRX length/Priority access associated with the PDU session, wake up signal (WUS) assistance information carried in Ntrf_PagingRequest message, or in a SBI container which may be carried by Ntrf_PagingRequest or SBI message. The UCF may provide a list of iNBs, or TRF based on Registration Area list to determine the relevant iNBs for paging. The TRF may handle the paging based on its paging strategy.

The UCF may send a notification to the WTRU to notify the WTRU about the PDU session association if the WTRU is simultaneously registered over both 3GPP and non-3GPP access and the PDU session ID is associated with non-3GPP access. In other words, one access network is selected, and a notification is sent to the WTRU of a PDU session over the selected access network when the WTRU is simultaneously registered over more than one access network, for example a WiFi network and a 3GPP network.

The UCF may receive information/notification from the TRF that WTRU has now been paged. Upon reception of the paging notification from TRF the UCF may initiate the WTRU configuration update procedure to assign new Temp-ID to the WTRU. If the Service Request includes a Reject Paging Indication, the TRF may trigger release of the WTRU by notifying the UCF and the SMF.

Here, aspects of the UPF are described. A UPF may receive session configuration information including a UCF ID from an SMF during PDU Session establishment/modification.

The UPF may receive DL data for the WTRU, and the UPF may notify the UCF of incoming DL Data for the WTRU. The UPF may receive WTRU connectivity related information from UCF, for example, reachability status, last serving iNB, serving TRF, data policy related information to indicate whether UPF may buffer the DL data or not, failure notification if WTRU is unreachable.

The UPF may send a request to page the WTRU to the last serving iNB, directly or via a TRF. The UPF may (re) establishes a tunnel/data connection for WTRU traffic with the current serving iNB, for example upon request from SMF.

The UPF may send the DL data to the WTRU.

Mobile Terminated (MT) short message service (SMS) using SBI.

When a short message service function (SMSF) receives MT SMS, the SMSF may send the request towards the TRF, or directly towards the RAN (last iNB used by the WTRU), and TRF/RAN then trigger the paging or service request procedure for the UE.

SMSF behavior: The SMSF receives Mobile Terminating SMS. The SMSF may invoke Ntrf_MT_EnableUEReachability service operation to TRF by sending a reachability request to the TRF. The SMSF may receive a Ntrf_MT_EnableUEReachability response from the TRF that indicates the state of the WTRU and success or failure as a result of paging.

The SMSF may invoke a Nran_MT_EnableUEReachability service operation, or an SBI message using signaling over SBI with RAN (iNB), for example, an interface for direct communication between the SMSF and RAN, by sending a reachability request to the RAN.

The SMSF may receive a Nran_MT_EnableUEReachability response from the RAN that indicates the state of the WTRU and success or failure as a result of paging. The SMSF may forward the SMS message to be sent to the WTRU via TRF by invoking a Ntrf_SBI_MessageTransfer service operation between TRF and SMSF or directly via RAN by invoking a SBI message transfer via RAN (iNB) where SMSF sends message to the iNB and then iNB transfers the SMS message to the WTRU.

The SMSF may receive an acknowledgment from the WTRU via iNB or via TRF that SMS is received. The SMSF may receive a delivery report from the WTRU via iNB or via TRF, and the SMSF may acknowledge receipt of the delivery report to the WTRU.

A procedure for a network triggered service request is described. This procedure may applicable when the network determines that MT data needs to be sent to a WTRU. Downlink User Plane Data, SMS data, and Control messages, for example NAS, that are sent to the WTRU are examples of MT Data. For example, the procedure may be triggered by any NF, for example a UPF for User Plane connection activation for PDU Session(s) to deliver mobile terminating user data, SMSF for Mobile-terminated SMS, UCF/PCF for WTRU configuration update and so forth. The following procedure is described using the UPF as an example, but the procedure can be updated as required by replacing the UPF with the respective NF, for example, SMS Function (SMSF), UCF, SMF, that needs to trigger the service request procedure. It should be appreciated that the following description is not intended to be limiting in any aspect, and it should be understood that similar procedures may be applied with any other network function.

The example may be applicable to the case that the WTRU is registered with the network, but the UPF does not know whether the WTRU needs to be paged, therefore the UPF may check with the UCF directly or via SMF. The UCF may determine the state of the WTRU and based on the state the UCF may decide whether the WTRU needs to be paged or not.

A new SBI (Service Based Interface) mechanism and NFs are presumed. It is also presumed that each NF may directly communicate with any other NF, whether the NF is located within the core network or a evolved access network, such as an iNB, using SBI. The network function IDs may be the respective IP addresses, and for the internal SBI communications between the NFs, for example TRF and UCF, SMF and UCF, the UE/WTRU ID can be a Temporary ID, SUCI, or SUPI. In the legacy systems, the WTRU state can be Reachable, Unreachable, CM_CONNECTED or CM_IDLE, but in the next generation cellular system, some additional states or even stateless communication may be considered. Hence, the following description will be considered applicable to existing states or any new state definition.

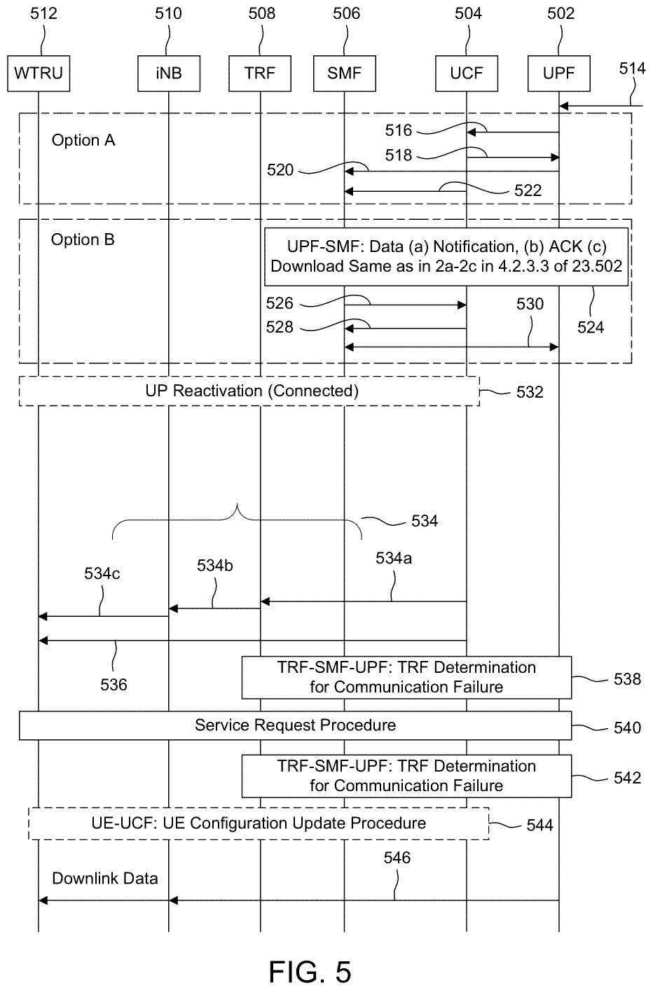

FIG. 5 is an example signal flow for a network triggered service request using SBI mechanism.

UPF 502 receives downlink data for a PDU session at 514. Here, UPF 502 may have the following alternatives; Option A where UPF 502 sends data notification to UCF 504 to check if WTRU 512 is reachable or not and what is the state of the WTRU 512, Option B where UPF 502 sends data notification to SMF 506 and SMF 506 checks with UCF 504 if WTRU 512 is reachable or not and what the current state of WTRU 512 is, and Option C, not shown, to send the downlink data to the AN (iNB 510) when UPF 502 knows that WTRU 512 is reachable and UPF 502 has AN tunnel info. In yet another option, also not shown, UPF 502 may forward the received downlink data to an AN, blindly, by selecting an AN only based on a contextual information, possibly derived from the packet header, such as application ID, an external identifier, or user ID, or source ID. The AN may in turn page WTRU 512 using mobility analytics or operator policies, for example based on the Application ID, by mapping applications to tracking areas.

UPF 502 may or may not have AN tunnel info stored in UPF for the PDU session, based on instructions from the UCF 504 (Option A), or SMF 506 (Option B), UPF 502 may buffer the downlink data or forward it to SMF 506.

During the PDU Session establishment procedure, UPF 502 may receive a UCF ID, PDU session ID, and UE/WTRU ID from SMF 506. For example, this may be part of an N4 session establishment. Similarly, during the PDU Session establishment procedure, UCF 504 may receive UPF ID, PDU session ID, and UE/WTRU ID from SMF 506. This information is then stored in the UPF and/or UCF, and may be associated with the N4 session ID or PDU session ID. If UPF 502 has stored the information provided at PDU session establishment, UPF 502 may use this information to re-establish the connectivity when the Downlink data is received at UPF 502 for the PDU session. Similarly, if the information is stored in UCF 504, the UCF may use this information to update or to retrieve WTRU 512 context when requested.

Alternatively, UPF 502 has direct SBI access to other NFs such as UCF 504, RAN (INBs) 510, etc.

In that case UPF 502 and UCF 504 have a direct link, and UCF 504 can subscribe to UPF notifications, for example, UPF 502 may notify UCF 504 that DL data has arrived to the UPF. When UCF 504 is informed of UPF 502 info by SMF 506 at setup/modification time. SMF 506 may setup the session binding between UCF 504 and UPF 502 when setting up N4 with UPF.

Similarly, UPF 502 may notify RAN (iNBs) 510 directly based on the session/tunnel info obtained from UCF 504, if available, for example bypass SMF/AMF.

### Option A

(UPF-UCF) Upon receiving Downlink data at 514, if UPF 502 does not know whether WTRU 512 is reachable, UPF 502 may need to determine if WTRU 512 is reachable by requesting information from UCF 504. To determine if WTRU 512 is reachable, UPF 502 sends a DL Data notification to UCF 504 at 516 including the known (e.g., previously known) N4 session ID, PDU session ID, Information to identify the QoS flow for the DL data packet and any additional data traffic and management related information that is stored in UPF 502 for the PDU session.

(UCF-UPF) UCF 504 may have previously received N4 session ID or PDU session ID from SMF 506 and it may have stored that information, for example the information may be stored in the WTRU context information. Upon reception of DL Data notification from the UPF at 516, UCF 504 may determine the state of WTRU 512. To determine the state of WTRU 512, UCF 504 may perform any of the following actions: match the N4 session ID/PDU session ID (e.g., from the DL Data notification) with the information stored in UCF 504, for example in the WTRU context information, and determine the state of WTRU 512 where the state may be CM-IDLE, CM-CONNECTED, reachable, or unreachable etc.

UCF 504 may be aware of WTRU 512 state by receiving an update from the iNB 510, for example during a handover procedure, or from WTRU 512, or from TRF 508 about the state of WTRU 512. For example, WTRU 512 or TRF 508 may send a message/notification to UCF 504 indicating a state change in WTRU 512 (event triggered) and UCF 504 may store the state information in the WTRU context. In another example, during a handover procedure between a source or target iNB, UCF 504 may receive information about the new serving iNB (from the source and/or target iNB) which UCF 504 stores in the WTRU context. Additionally, iNB 510 may provide other WTRU 512 state information to UCF 504. For example, iNB 510 may send a message/notification to UCF 504 indicating a change of the WTRU RRC state (e.g. change of state between RRC Connected, RRC Idle, or RRC_Inactive). If UCF 504 determines that WTRU 512 is in a CM-IDLE state or unreachable or reachable only for regulatory prioritized service or the Extended Buffering does not apply, UCF 504 may send Data Notification Response 518 to UPF 502 to indicate that WTRU 512 is unreachable; Data Notification Response 518 may additionally include the state of WTRU 512 and information related to present and/or future DL data management. For example, the data management information may indicate to stop sending a Data Notification to UCF 504 for the WTRU ID and/or N4 session ID and/or PDU session ID, to stop buffering DL data for the WTRU ID and/or N4 session ID and/or PDU session ID, or to discard data for the WTRU ID and/or N4 session ID and/or PDU session ID.

If UCF 504 determines that the WTRU state is CM-CONNECTED mode, then UCF 504 may send Data Notification Response 518 to UPF 502 to indicate that WTRU 512 is reachable. Data Notification Response 518 may include the state of the WTRU and data policy information indicating whether the data should be buffered at UPF 502 or forwarded to SMF 506 for buffering, it may also provide the buffer time, or extended time information.

(UPF-SMF) If the Data Notification Response at 518 includes data policy information, UPF 502 may forward the downlink data packet to SMF 506 at 520, if the data policy information indicates to buffer at SMF 506. Otherwise, the data is buffered at UPF 502 and the downlink packet is not forwarded at 520.

(UCF-SMF) If UCF 504, based on the signaling at 516 and 518, determines that the state of WTRU 512 is CM-CONNECTED mode then UCF 504 may send Nucf_UpdateUEContextNotification to SMF 506 at 522 that includes WTRU ID or SUCI, PDU session ID, a list of iNBs, WTRU status information, which is used later by SMF 506 for user plane reactivation, for example PDU session establishment or modification procedure if WTRU 512 is in connected mode.

### Option B

(UPF-SMF) UPF 502 may send DL Data notification to SMF 506 for the PDU session at 524, where SMF 506 has information of the PDU session.

(SMF-UCF) SMF 506, based on DL data notification at 524, may send a WTRU context update request to UCF 504 Nucf_UpdateUEContextRequest at 526, and this may include WTRU ID or SUCI, PDU session ID, 5QI/6QI, SBI container (SBI SM message (DNN, S-NSSAI).

Based on the instructions from UCF 504, SMF 506 may subscribe to UCF 504 for notifications for the WTRU, for example when WTRU 512 is coming “online,” or the state of WTRU 512 is changed then UCF 504 may notify SMF 506. Similarly, WTRUs and NFs (such as SMF 506 in this example) may notify UCF 504 for any updates related to PDU session for the WTRU.

(UCF-SMF) UCF 504, upon reception of Nucf_UpdateUEContextRequest at 526, may retrieve WTRU context for WTRU 512, which is maybe locally stored in UCF 504. If UCF 504 doesn't have up-to-date status info of WTRU 512, it may determine status info by requesting a status update from TRF 508. The request to TRF 510 may include the UE ID and the status info request. TRF 508 may respond to UCF 504 with WTRUs status info.

UCF 504 may respond to SMF 506 with a WTRU context update response Nucf_UpdateUEContextResponse at 528, and this may include SUCI, PDU session ID, 5QI/6QI, and WTRU state information.

UCF 504 may be aware of the WTRU state by receiving an update from iNB 510, for example during a handover procedure, or from WTRU 512, or from TRF 508 about the WTRU state. For example, WTRU 512 or TRF 508 may send a message/notification to UCF 504 indicating the WTRU state change (event triggered) and UCF 504 may store the state information in the WTRU context. In another example, during a handover procedure between a source or target iNB, the UCF may receive information about the new serving iNB (from the source and/or target iNB) which the UCF stores in the WTRU context. Additionally, the iNB may provide other WTRU state information to the UCF. For example, iNB 510 may send a message/notification to UCF 504 indicating a change of WTRU RRC state, for example change of state between RRC Connected, RRC Idle, or RRC_Inactive.

(UCF-SMF) and (UCF-UPF) If UCF 504 after 526 determines that the state of the WTRU is unreachable or reachable only for regulatory prioritized service or the Extended Buffering does not apply, UCF 504 may send a failure indication to SMF 506 and/or UPF 502, at 530 to indicate at least one of the following conditions, to stop sending Data Notification, stop buffering DL data, or to discard data.

(SMF-WTRU) If WTRU 512 is in CM-CONNECTED state as determined at 518 or 528, UCF 504 may initiate radio resource establishment and the PDU session establishment/modification request for the requested PDU session to activate the User Plane to establish N3 tunnel at 532. In this case, UCF 504 does not need to send the paging message to iNB 510 or WTRU 512 via TRF 508 and 534-544 may be skipped.

UCF (or SMF) when UCF 504 or SMF 506 determines that WTRU 512 is in a CM-CONNECTED state then it may not need to notify TRF 508 that paging message is required.

The process at 534 summarizes a paging message which may be triggered by the UCF 504 or SMF 506 where the UCF or SMF may notify the TRF 508 when there is a need to page WTRU 512. The paging message may be executed as follows:

(UCF-TRF) When UCF 504 receives a notification about pending DL data traffic from UPF 502 or SMF 506, UCF 504 checks the state of WTRU 512 and determines if the WTRU is in CM_CONNECTED state or CM_IDLE state. If the WTRU is in CM_IDLE state, UCF 504 triggers a paging procedure. As part of this procedure, TRF 508 is notified by UCF 504 when there is a need to page the WTRU at 534a. There may be a new message defined, Ntrf_PagingRequest message, which includes the WTRU ID, PDU session ID, Registration Area list, Paging DRX length/Priority access associated to the PDU session, wake up signal (WUS) assistance information carried in Ntrf_PagingRequest message, or in SBI container which is carried by Ntrf_PagingRequest or SBI message.

UCF 504 may provide a list of iNBs, or TRF based on Registration Area list may determine the relevant iNBs for paging. TRF 508 handles the paging based on its paging strategy.

TRF 508 may start to monitor how long it takes for the WTRU to respond with a Paging response (e.g. a service request like message). If the response is not received within a certain time, for example implemented by a timer, TRF 508 may declare a Paging failure. Similarly, if the response is received within a certain time, TRF 508 may declare a Paging success.

TRF 508 may acknowledge UCF 504 or may wait for the Paging success/failure and then respond to UCF 504 at 538.

If WTRU 512 is already online or unreachable, then UCF 504 may directly notify SMF 506 and UPF 502 as in 530 and 532, and the procedure following 534 may not be needed.

(TRF-iNB) At 534b, TRF 508 forwards the paging request to the selected iNB(s) if WTRU 512 is in registered state and CM-IDLE and reachable in 3GPP access. TRF 508 may include some or all the parameters received from UCF 504 in 534a.

(iNB-WTRU) WTRU 512 is paged by iNB 510 at 534c.

In an alternative embodiment, instead of 534a and 534b, SMF 506 may trigger the paging towards the RAN (iNB), directly or via a TRF. In another alternative embodiment, the RAN may trigger the paging directly upon UPF data notification, where UPF 502 notifies iNB 510 (last known iNB), which may act as a paging coordination function, for example iNB 510 tries to page WTRU 512 first and/or contact other iNBs via a direct interface or through core (SBI) based on the UCF info.

Alternatively, the UCF or SMF can consult the NWDAF AIML model to find a list of iNB that the WTRU may be reached with maximum probability of being paged.

RAN (iNB) 510 may inform TRF 508 that WTRU 512 is here, based on that indication TRF 508 may notify SMF 506 to reactivate the PDU session and continue with the rest of the session management procedure.

(UCF-WTRU) WTRU 512 may be simultaneously registered over both 3GPP access and non-3GPP access. In such a case, UCF 504 may select one access network and send a notification to WTRU 512 of a PDU session over the selected access network at 536. For example, selecting one of a WiFi access network or a 3GPP access network and sending a notification of the PDU session over the selected WiFi access network or a 3GPP access network.

UCF 504 may pick a data path to notify WTRU 512 based on the configured policy/strategy, for example if WTRU 512 is in connected mode, then UCF 504 may pick 3GPP access, e.g., SBI Notification message, and if WTRU 512 is in idle mode, then UCF 504 may use non-3GPP access to deliver the notification to WTRU 512.

(TRF) TRF 508 monitors paging procedure with a timer value and waits for the response from the WTRU. If no response is received from the WTRU, TRF 508 declares communication failure and may inform SMF 506 and UPF 502 by sending Failure notification with respective cause code, e.g., UE unreachable, UE not-responding etc. at 538.

(WTRU) If WTRU 512 receives the page, the WTRU may attempt to move to the CM-CONNECTED state by sending a service request message to the network, e.g., service request message is sent to UCF 504, TRF 508 or RMF via iNB 510 at 540.

(TRF) TRF 508 monitors paging procedure with a timer value and waits for the response from the WTRU. If the timer expires or if the TRF receives a service reject message from the WTRU, then the TRF declares communication failure and may inform SMF 506 and UPF 502 by sending Failure notification with respective cause code, for example WTRU unreachable, WTRU not-responding etc. at 542

(UCF-WTRU) TRF 508 pages WTRU 512, and TRF 508 may inform/notify UCF 504 that WTRU 512 has now been paged at 544. Upon reception of the paging notification from TRF 508, UCF 504 initiates the WTRU configuration update procedure to assign new Temp-ID to the WTRU. If the Service Request includes a Reject Paging Indication at 542, the TRF may trigger release of the ATRU by notifying the UCF and the SMF.

(UPF/SMF-WTRU) If UPF 502 was buffering the DL data, the UPF may transmit the data to WTRU 512 via RAN (iNB) 510. If SMF 506 was buffering the DL data then the SMF forwards the buffered DL data to UPF before it is transmitted to the WTRU at 546.

It is worth noting that 538-546, may be triggered or skipped under different conditions including: 1) if the TRF monitors paging procedure with a timer value and the timer expires then steps following 538 may be skipped, and the call flow ends; 2) If the WTRU is paged and it responds with a service reject, then 544 and 546 are skipped; and 3) If the WTRU is paged and it responds with the paging response 540-546 are performed, but 542 is skipped.

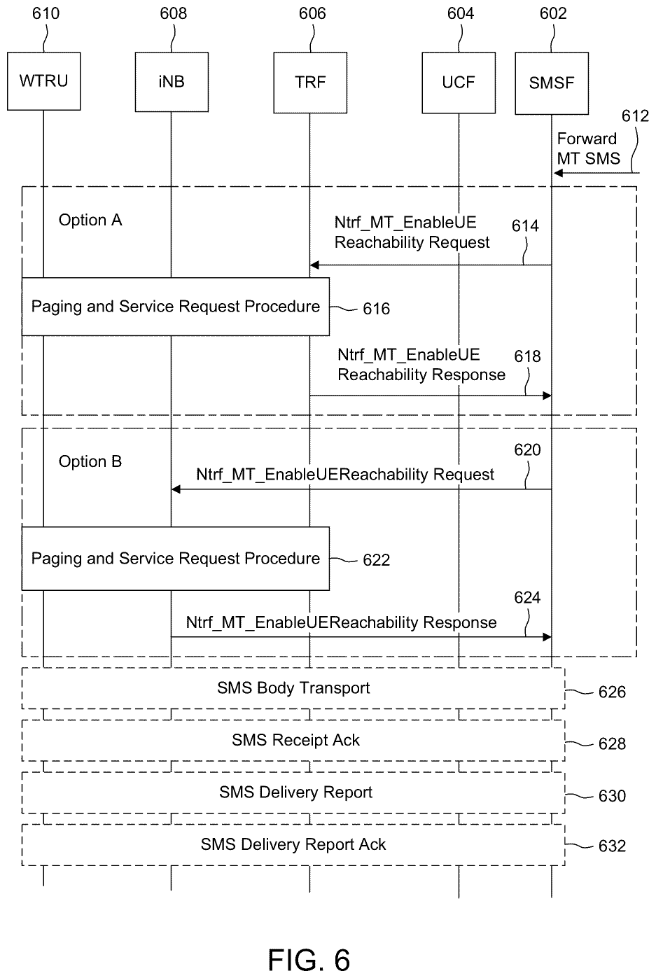

As aspect of MT SMS using SMBI is described with reference to FIG. 6.

FIG. 6 illustrates an example signal flow applicable when the SMSF determines that MT SMS may need to be forward to a WTRU. SMSF 602 invokes the SMS forward and may have two alternatives; Option A where SMSF 602 sends the request towards TRF 606, or Option B where SMSF 602 sends the request towards the RAN (iNB) 608 directly, which could be the last iNB the WTRU was connected with or any iNB that is visible to SMSF and that iNB coordinates with the other iNBs.

Alternatively, SMSF 602 may use some of the techniques specified for an alternative option, for example forwarding the SMS to an AN (e.g., a iNB) based on network operator policies and or header information such as message source.

The signal flow illustrated in FIG. 6 may be implemented to send SMS to the WTRU using the end-to-end SBI mechanism. (SMSF) SMSF receives Mobile Terminating SMS at 612.

### Option A

(SMSF-TRF) SMSF 602 checks the SMS management subscription data. If SMS delivery is allowed, SMSF 602 invokes Ntrf_MT_EnableUEReachability service operation to TRF 606 by sending a reachability request to the TRF at 614.

Depending upon the state of the WTRU being CM_IDLE or CM_CONNECTED, TRF 606 may trigger the paging or service request at 616 to move the WTRU to CM_CONNECTED, following the procedure as illustrated in FIG. 5.

TRF 606 sends a Ntrf_MT_EnableUEReachability response to SMSF 602 at 618 to indicate the state of the WTRU and to indicate success or failure as result of paging.

### Option B

(SMSF-RAN) The process in Option B is similar to 614-618 in Option A, but TRF 606 is replaced with the RAN (iNB 608) implying that SMSF 602 invokes Nran_MT_EnableUEReachability service operation, or an SBI message using signaling over SBI at 620, for example interface for direct communication between SMSF 602 and the RAN (iNB 608).

Alternatively, SMSF 602 may request from the UCF for the WTRU reachability status or subscribe to UCF 604 for a WTRU reachability notification, whereby the WTRU reachability status in UCF 604 may be updated upon one or more messages received from TRF 606 and/or RAN 608, for example following a previous failed paging procedure.

(SMSF-WTRU) SMSF 602 may forward the SMS message to be sent to WTRU 610 via TRF 606 by invoking Ntrf_SBI_Message Transfer service operation between TRF 606 and SMSF 602 or directly via RAN by invoking SBI message transfer via RAN (iNB) where SMSF 602 sends a message to iNB 608 and iNB 602 transfers the SMS message to WTRU 610 at 626. The SMS message may be encapsulated in a SBI payload, for example in an end-to-end SBI message between SMSF 602 and WTRU 610, and forwarded transparently by iNB 608 to WTRU 610.

(WTRU-SMSF) WTRU 610 acknowledges the receipt of the SMS message at 628 and sends a delivery report to SMSF 602 via iNB 610 or via TRF 606 at 630.

(SMSF-WTRU) SMSF 602 acknowledges receipt of the delivery report to WTRU 610 at 632.

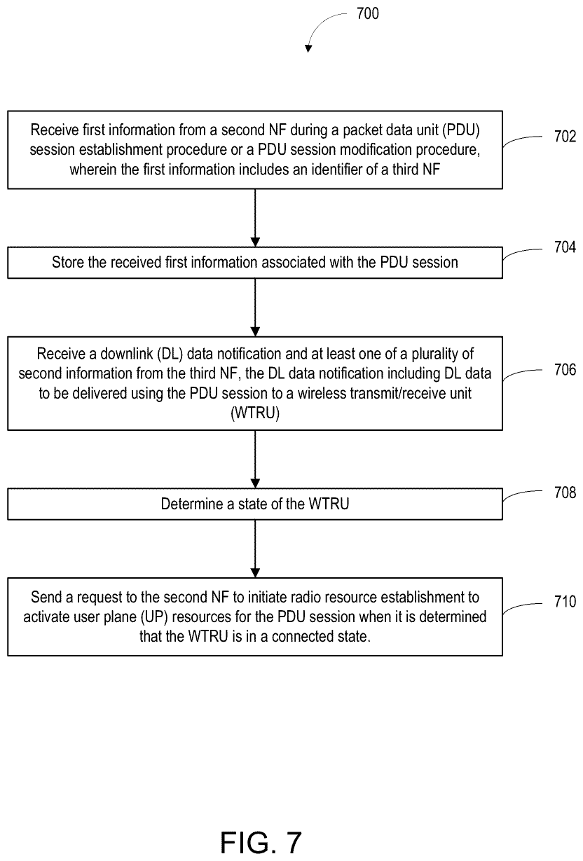

FIG. 7 is a flow diagram of an exemplary process of a network triggered service request using an SBI.

As shown in FIG. 7, process 700 may include receiving first information from a second NF during a packet data unit (PDU) session establishment procedure or a PDU session modification procedure, where the first information includes an identifier of a third NF at 702. For example, a first NF may receive first information from a second NF during a PDU session establishment procedure or a PDU session modification procedure, where the first information includes an identifier of a third NF, as described above. As also shown in FIG. 7, process 700 may include storing the received first information associated with the PDU session at 704. For example, the first NF may store the received first information associated with the PDU session, as described above. As further shown in FIG. 7, process 700 may include receiving a downlink (DL) data notification and at least one of a plurality of second information from the third NF, the DL data notification including DL data to be delivered using the PDU session to a wireless transmit/receive unit (WTRU) at 706. For example, the first NF may receive a DL data notification and at least one of a plurality of second information from the third NF, the DL data notification including DL data to be delivered using the PDU session to a wireless transmit/receive unit (WTRU), as described above. As also shown in FIG. 7, process 700 may include determining a state of the WTRU at 708. For example, the first NF may determine a state of the WTRU, as described above. As further shown in FIG. 7, process 700 may include sending a request to the second NF to initiate radio resource establishment to activate user plane (UP) resources for the PDU session when it is determined that the WTRU is in a connected state at 710. For example, the first NF may send a request to the second NF to initiate radio resource establishment to activate UP resources for the PDU session when it is determined that the WTRU is in a connected state, as described above.

Although not shown, process 700 may include additional implementations, such as any single implementation or any combination of implementations described below and/or in connection with one or more other processes described elsewhere herein. In a first implementation, the first information may include at least one of a PDU session ID, or a WTRU ID, where the first information is associated with WTRU context information, and where the plurality of second information includes one or more of: an N4 session ID, PDU session ID, information to identify a QoS flow for a DL data packet, and management information associated with the stored first information.

In a second implementation, alone or in combination with the first implementation, determining the state of the WTRU includes performing at least one of: matching N4 session ID/PDU session ID in the DL data notification with the stored first information and confirming whether the WTRU is in a connected state, a disconnected state, is reachable, or is unreachable.

In a third implementation, alone or in combination with the first and second implementation, 4. The method of may include forwarding DL packet data to the second NF when the second information includes data policy information and the data policy information indicates to buffer data at the second NF.

A fourth implementation, alone or in combination with one or more of the first through third implementations, process 700 may include sending a data notification acknowledgement to the third NF when it is determined that the WTRU is in a connected state, where the data notification acknowledgement includes at least one of a WTRU identifier, PDU session ID, a list of intelligent network base stations (iNB), or WTRU status information.

A fifth implementation, alone or in combination with one or more of the first through fourth implementations, process 700 further includes receiving a WTRU context update request from the second NF based on the DL data notification received from the third NF, retrieving the WTRU context information associated with the stored first information or requesting a status update from a fourth NF when the WTRU context information stored is not current, and sending a WTRU context update response to the second NF.

A sixth implementation, alone or in combination with one or more of the first through fifth implementations, process 700 may include sending a failure indication to at least one of the second NF and the third NF to indicate the WTRU is unreachable, where the failure indication includes information indicating to perform at least one of: stop sending data notification, stop buffering DL data, or discard data.

A seventh implementation, alone or in combination with one or more of the first through sixth implementations, process 700 may include triggering a paging message to notify a fourth NF or a RAN node when it is determined that the WTRU is in an idle state.

An eighth implementation, alone or in combination with one or more of the first through seventh implementations, process 700 may include selecting one access network and sending a notification to the WTRU of a PDU session over the selected one access network when the WTRU is simultaneously registered over more than one access network.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method implemented in a first network function (NF), the method comprising:
receiving first information from a second NF during a packet data unit (PDU) session establishment procedure or a PDU session modification procedure, wherein the first information includes an identifier of a third NF;
storing the received first information associated with the PDU session;
receiving a downlink (DL) data notification and at least one of a plurality of second information from the third NF, the DL data notification including DL data to be delivered using the PDU session to a wireless transmit/receive unit (WTRU);
determining a state of the WTRU; and
sending a request to the second NF to initiate radio resource establishment to activate user plane (UP) resources for the PDU session when it is determined that the WTRU is in a connected state.

2. The method of claim 1, wherein the first information includes at least one of a PDU session ID, or a WTRU ID, wherein the first information is associated with WTRU context information, and wherein the plurality of second information includes one or more of: an N4 session ID, PDU session ID, information to identify a QoS flow for a DL data packet, and management information associated with the stored first information.

3. The method of claim 2, wherein determining the state of the WTRU includes performing at least one of: matching N4 session ID/PDU session ID in the DL data notification with the stored first information and confirming whether the WTRU is in a connected state, a disconnected state, is reachable, or is unreachable.

4. The method of claim 2 further comprising forwarding DL packet data to the second NF when the second information includes data policy information and the data policy information indicates to buffer data at the second NF.

5. The method of claim 2, further comprising sending a data notification acknowledgement to the third NF when it is determined that the WTRU is in a connected state, wherein the data notification acknowledgement includes at least one of a WTRU identifier, PDU session ID, a list of intelligent network base stations (iNB), or WTRU status information.

6. The method of claim 5, further comprising:
receiving a WTRU context update request from the second NF based on the DL data notification received from the third NF;
retrieving the WTRU context information associated with the stored first information or requesting a status update from a fourth NF when the WTRU context information stored is not current; and
sending a WTRU context update response to the second NF.

7. The method of claim 5, further comprising sending a failure indication to at least one of the second NF and the third NF to indicate the WTRU is unreachable, wherein the failure indication includes information indicating to perform at least one of: stop sending data notification, stop buffering DL data, or discard data.

8. The method of claim 2, further comprising triggering a paging message to notify a fourth NF or a radio access network (RAN) node when it is determined that the WTRU is in an idle state.

9. The method of claim 2, further comprising selecting one access network and sending a notification to the WTRU of a PDU session over the selected one access network when the WTRU is simultaneously registered over more than one access network.

10. A first network function (NF) apparatus comprising:
a transceiver configured to receive first information from a second NF during a packet data unit (PDU) session establishment procedure or a PDU session modification procedure, wherein the first information includes an identifier of a third NF; and
processing circuitry configured to store the first information associated with the PDU session;
the transceiver configured to receive a downlink (DL) data notification and at least one of a plurality of second information from the third NF, the DL data notification including DL data to be delivered using the PDU session to a wireless transmit/receive unit (WTRU);
the processing circuitry configured to determine a state of the WTRU; and
the transceiver configured to send a request to the second NF to initiate radio resource establishment to activate user plane (UP) resources for the PDU session when it is determined that the WTRU is in a connected state.

11. The first NF apparatus of claim 10, wherein the first information includes at least one of a PDU session ID, or a WTRU ID, wherein the first information is associated with WTRU context information, and wherein the plurality of second information includes: an N4 session ID, PDU session ID, information to identify a QoS flow for a DL data packet, data traffic, and management information associated with the stored first information.

12. The first NF apparatus of claim 11 wherein the processing circuitry is configured to determine the state of the WTRU by comparing at least one of: N4 session ID/PDU session ID in the DL data notification with the stored first information and establishing whether the WTRU is in a connected state, a disconnected state, is reachable, or is unreachable.

13. The first NF apparatus of claim 11, wherein the transceiver is further configured to forward DL packet data to the second NF when the second information includes data policy information and the data policy information indicates to buffer data at the second NF.

14. The first NF apparatus of claim 11, wherein the transceiver is further configured to send a data notification acknowledgement to the third NF when it is determined that the WTRU is in a connected state, wherein the data notification acknowledgement includes at least one of a WTRU identifier, PDU session ID, a list of intelligent network base stations (iNB), or WTRU status information.

15. The first NF apparatus of claim 14, wherein the transceiver is further configured to:
receive a WTRU context update request from the second NF based on the DL data notification received from the third NF;
retrieve the WTRU context information associated with the stored first information or requesting a status update from a fourth NF when the WTRU context information stored is not current; and
send a WTRU context update response to the second NF.

16. The first NF apparatus of claim 14, wherein the transceiver is further configured to send a failure indication to at least one of the second NF and the third NF to indicate the WTRU is unreachable, wherein the failure indication includes information indicating to perform at least one of: stop sending Data Notification, stop buffering DL data, or discard data.

17. The first NF apparatus of claim 11, wherein the transceiver is further configured to trigger a paging message to notify a fourth NF or a Radio Access Network (RAN) node when it is determined that the WTRU is in an idle state.

18. The first NF apparatus according of claim 11, wherein the transceiver is further configured to select one access network and transmit a notification to the WTRU of a PDU session over the selected one access network when the WTRU is simultaneously registered over more than one access network.
